(19) United States
(12) Patent Application Publication
(10) Pub. No.: US 2026/0194938 A1
(43) Pub. Date: Jul. 9, 2026

(54) ELECTRONIC APPARATUS

(71) Applicant: LENOVO JAPAN LLC, YOKOHAMA (JP)

(72) Inventors: Kanya Sugitani, YOKOHAMA (JP); Akashi Takashima, YOKOHAMA (JP); Jun Iwasaki, YOKOHAMA (JP); Toshiya Sakai, TOKYO (JP)

(73) Assignee: LENOVO JAPAN LLC, YOKOHAMA (JP)

(21) Appl. No.: 19/230,479

(22) Filed: Jun. 6, 2025

(30) Foreign Application Priority Data
Jan. 8, 2025 (JP) 2025002679

(51) Int. Cl. G06F 1/16

(52) U.S. Cl. CPC G06F 1/1681

(57) ABSTRACT

An electronic apparatus includes: a hinge mechanism rotatably connecting a first chassis and a second chassis; a flexible board extending across the first chassis and the second chassis; a cooling mechanism releasing air in the second chassis through the exhaust port; and an antenna in the second chassis. The flexible board, antenna, and hinge mechanism are disposed side by side in the order in a first direction that is an axial direction of the hinge mechanism. The flexible board includes a flexible board and one or more conductive layers. The at least one conductive layer has a recess in a side edge facing the antenna, the recess being defined by at least one of a narrow portion and a bend of the conductive layer.

### BACKGROUND OF THE INVENTION

### Field of the Invention

The present invention relates to an electronic apparatus.

### Description of the Related Art

An electronic apparatus such as a laptop PC includes a first chassis in which a display is mounted, and a second chassis in which a motherboard, a cooling mechanism and other components are mounted, for example. The first chassis and second chassis are connected to each other via a hinge mechanism. The electronic components in the first chassis and the electronic components in the second chassis are connected via a flexible board (see, for example, Japanese Patent No. 7011094). The cooling mechanism in the second chassis releases air that has become hot due to heat exchange with the CPU and other components through an exhaust port that opens on the rear end face of the second chassis (see, for example, Japanese Unexamined Patent Application Publication No. 2022-184649).

### SUMMARY OF THE INVENTION

Some electronic apparatuses include an antenna near the rear end of the second chassis. To enhance the communication characteristics of the antenna, the antenna is desirably located at a distance from the hinge mechanism and the flexible board. However, adjusting the left-right position of the flexible board to distance it from the antenna makes the size of the exhaust port insufficient, which can affect the heat dissipation performance of the cooling mechanism.

One aspect of the present invention aims to provide an electronic apparatus having communication characteristics of the antenna enhanced without degrading the heat dissipation performance of the cooling mechanism.

An electronic apparatus according to the first aspect of the present invention includes: a first chassis having a first base end and a first open end, a first component being mounted on the first chassis; a second chassis having a second base end with an exhaust port and a second open end, a second component being mounted on the second chassis; at least one hinge mechanism rotatably connecting the first base end and the second base end; at least one flexible board extending across the first chassis and the second chassis; a cooling mechanism disposed in the second chassis, the cooling mechanism releasing air in the second chassis through the exhaust port; and at least one antenna disposed in a vicinity of the second base end of the second chassis, the at least one flexible board, the at least one antenna, and the at least one hinge mechanism being disposed side by side in the order in a first direction that is an axial direction of the at least one hinge mechanism, the at least one flexible board including: a substrate being flexible; and at least one conductive layer on the substrate, the at least one conductive layer electrically connecting the first component and the second component, the at least one conductive layer having a recess in a side edge facing the at least one antenna, the recess being defined by at least one of a narrow portion and a bend of the conductive layer.

Preferably, the first component includes a display, the at least one flexible board includes a multilayer board having a first layer and a second layer, the first layer includes the at least one conductive layer including a logic ground layer that is connected to the display, the second layer includes the at least one conductive layer including a signal ground layer that is connected to the display, and the logic ground layer has one end that is electrically connected to the display and the other end that is electrically connected to the signal ground layer.

Preferably, a connection point between the logic ground layer and the signal ground layer is located at a position toward the display from the recess in a longitudinal direction of the at least one flexible board.

Preferably, the at least one conductive layer with the recess has a bend recessed toward a direction away from the at least one antenna.

Preferably, the at least one flexible board includes two flexible boards that are spaced apart in the first direction, the at least one antenna includes two antennas that are spaced apart in the first direction, and the at least one hinge mechanism includes two hinge mechanisms that are spaced apart in the first direction, the exhaust port is located between the two flexible boards in the first direction, the two antennas are located outside of the two flexible boards in the first direction, and the two hinge mechanisms are located outside of the two antennas in the first direction.

One aspect of the present invention provides an electronic apparatus having communication characteristics of the antenna enhanced without degrading the heat dissipation performance of the cooling mechanism.

### BRIEF DESCRIPTION OF THE DRAWINGS

FIG. 1 is a perspective view of an electronic apparatus according to one embodiment.

FIG. 2 is a top view of the electronic apparatus according to one embodiment.

FIG. 3 is a top view illustrating the internal structure of the electronic apparatus according to one embodiment.

FIG. 4 is a bottom view illustrating the internal structure of the electronic apparatus according to one embodiment.

FIG. 5 is a bottom view illustrating the internal structure of the electronic apparatus according to one embodiment.

FIG. 6 is a partial plan view of a first flexible board of the electronic apparatus according to one embodiment.

FIG. 7 is a partial plan view of a second flexible board of the electronic apparatus according to one embodiment.

FIG. 8 is a partial plan view of a flexible board according to a comparative example.

FIG. 9 is a graph showing test results.

FIG. 10 is a graph showing test results.

### DETAILED DESCRIPTION OF THE INVENTION

The following describes an electronic apparatus according to one embodiment.

### Electronic Apparatus

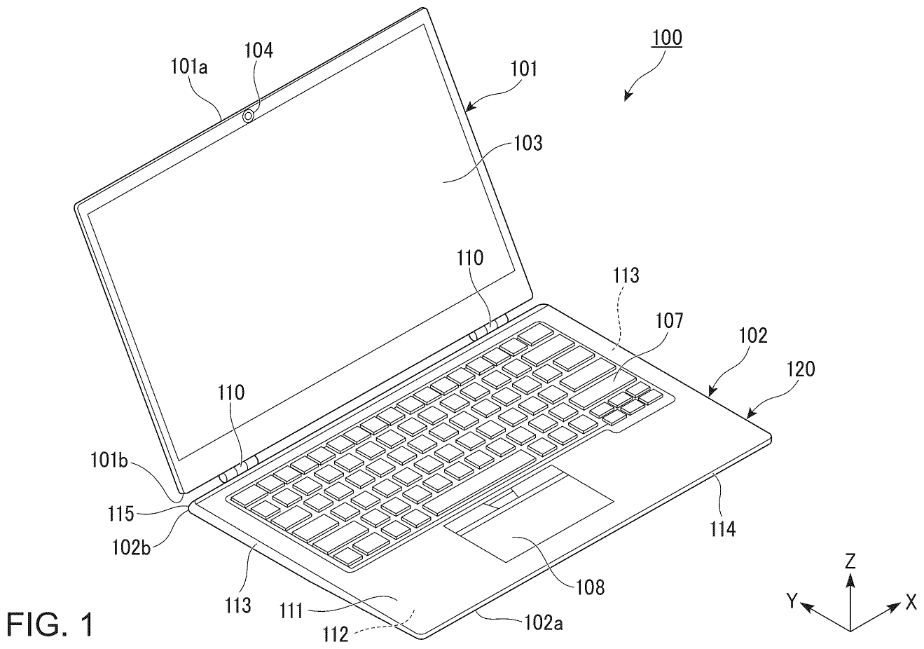

FIG. 1 is a perspective view of an electronic apparatus 100 according to one embodiment.

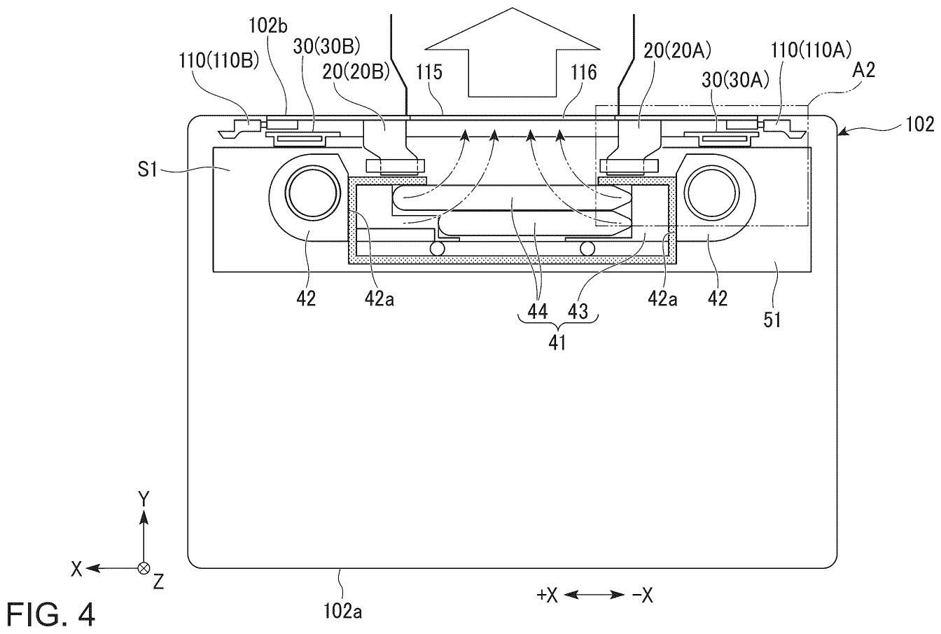

As illustrated in FIG. 1, the electronic apparatus 100 includes a first chassis 101, a second chassis 102, two hinge mechanisms 110, two flexible boards 20 (see FIG. 4), two antennas 30 (see FIG. 4), and a cooling mechanism 40 (see FIG. 4). In one example, the electronic apparatus 100 is a laptop personal computer (PC).

The first chassis 101 is also called a display chassis. The first chassis 101 has a rectangular plate form. One of the ends of the first chassis 101 is a first base end 101b. The end opposite to the first base end 101b is a first open end 101a. In the first chassis 101, a display 103 (display unit) and a camera 104 are mounted. In one example, the display 103 is a liquid crystal display or an organic electro-luminescence (EL) display. The display 103 and camera 104 are examples of “first components”.

The second chassis 102 is also called a system chassis. The second chassis 102 has a rectangular plate form. One of the ends of the second chassis 102 is a second base end 102b. The end opposite to the second base end 102b is a second open end 102a.

In the second chassis 102, a keyboard 107 and a touchpad 108 are mounted. The second chassis 102 houses electronic components such as a CPU, a memory, a motherboard, a battery, and a storage device. These electronic components are examples of “second components.” The keyboard 107 and touchpad 108 are examples of input units.

The following may describe the positional relationship of the components in the second chassis 102 using the XYZ orthogonal coordinate system. X direction is the axial direction of the hinge mechanism 110. Y direction is a direction connecting the second base end 102b and the second open end 102a of the second chassis 102. Y direction is orthogonal to X direction. Z direction is orthogonal to X direction and Y direction. Viewing in Z direction is called a plan view. +X side is one of the X directions. −X side is opposite to +X side. X direction is an example of a “first direction.” Y direction is an example of a “second direction.”

The second chassis 102 includes a main portion 120 and a second cover plate 112. The second chassis 102 is a case of a flat plate form. For instance, the second chassis 102 is made of metal or plastic.

The main portion 120 has a first cover plate 111, a pair of side plates 113, a front plate 114, and a rear plate 115. The first cover plate 111 is rectangular in plan view. The pair of side plates 113 are located on one and the other side edges of the first cover plate 111. The side plates 113 are perpendicular to the first cover plate 111. In this embodiment, the first cover plate 111 is the upper plate.

The front plate 114 is located at the front edge (second open end 102a) of the first cover plate 111. The rear plate 115 is located at the rear edge (second base end 102b) of the first cover plate 111.

The rear plate 115 has a plurality of exhaust ports 116 (see FIG. 4). These exhaust ports 116 are formed through the rear plate 115 in the thickness direction. For instance, the exhaust ports 116 are formed in the rear plate 115 at a portion including the center in X direction. The exhaust ports 116 have a plurality of openings aligned in X direction, for example.

The second cover plate 112 is rectangular in plan view. The second cover plate 112 faces the first cover plate 111 with a gap therebetween. When the second chassis 102 is placed on a placement surface, then the second cover plate 112 faces the placement surface. In this embodiment, the second cover plate 112 is a bottom plate.

The second chassis 102 has a housing space S1 (see FIG. 4) defined between the first cover plate 111 and the second cover plate 112. This housing space S1 is the interior space of the second chassis 102.

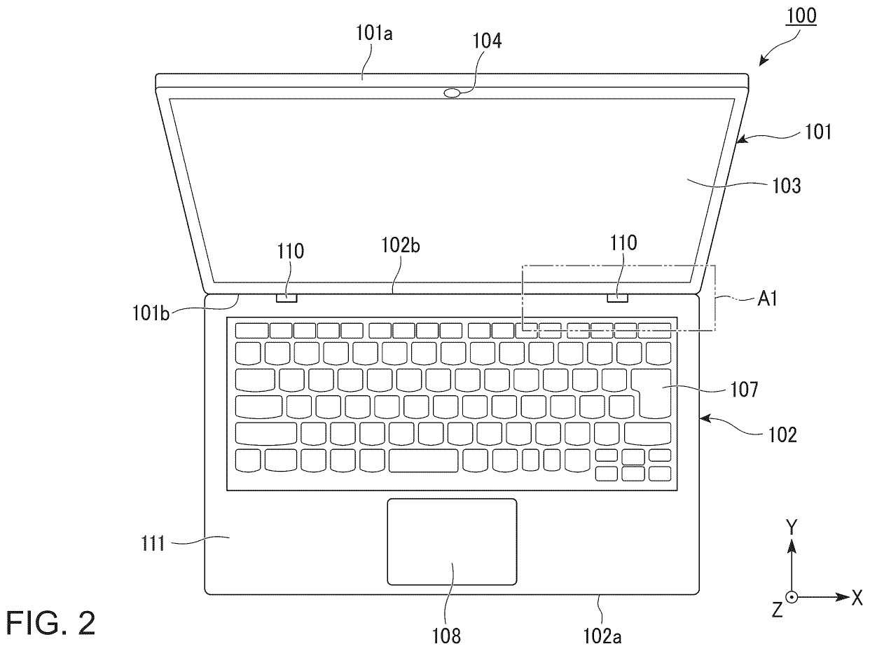

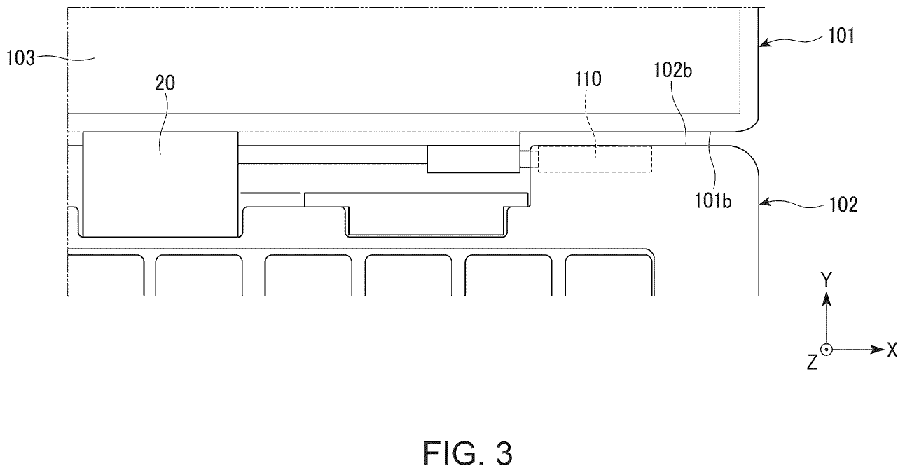

FIG. 2 is a top view of the electronic apparatus 100. FIG. 3 is a top view illustrating the internal structure of the electronic apparatus 100. FIG. 3 illustrates the internal structure of the section indicated A1 in FIG. 2.

As illustrated in FIG. 2 and FIG. 3, the hinge mechanisms 110 rotatably connect the first base end 101b of the first chassis 101 and the second base end 102b of the second chassis 102. This connects the first chassis 101 and the second chassis 102 via the hinge mechanisms 110. The first chassis 101 is rotatable relative to the second chassis 102 around the rotary shaft of the hinge mechanisms 110.

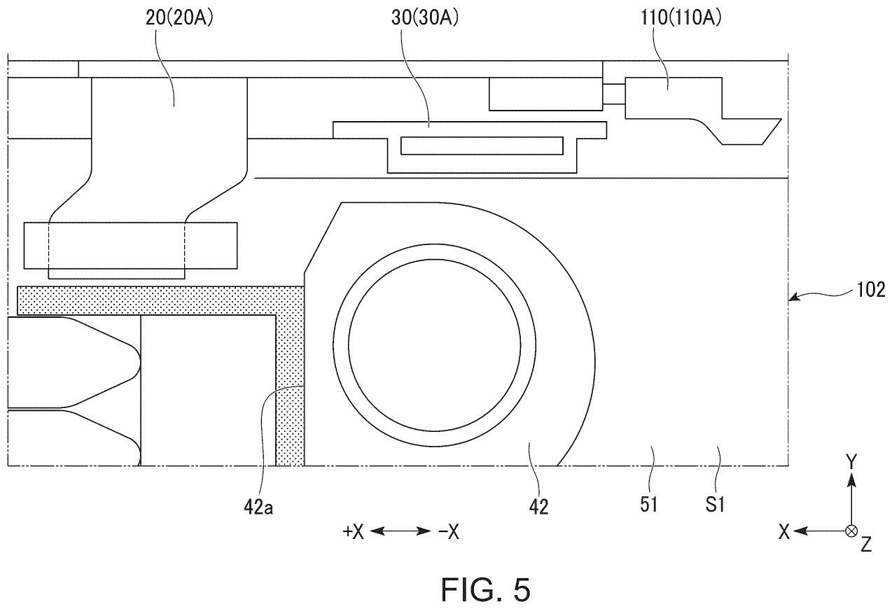

FIG. 4 is a bottom view illustrating the internal structure of the electronic apparatus 100. FIG. 5 is a bottom view illustrating the internal structure of the electronic apparatus 100. FIG. 5 illustrates the internal structure of the section indicated A2 in FIG. 4.

As illustrated in FIG. 4 and FIG. 5, the two hinge mechanisms 110 are placed apart in X direction. The two hinge mechanisms 110 are a first hinge mechanism 110A and a second hinge mechanism 110B. Each hinge mechanism 110 includes a rotating shaft, a bearing portion, and a bracket. The rotating shaft extends in X direction. The rotating shaft is inserted into the insertion hole of the bearing portion. The bracket is made of metal. The bracket is fixed to the second chassis 102, for example. The direction in which the two hinge mechanisms 110 are away from each other is outward in X direction. The direction in which the two hinge mechanisms 110 are closer to each other is inward in X direction.

For instance, the two hinge mechanisms 110 (e.g., brackets) are located outside in X direction relative to the antennas 30. That is, the two hinge mechanisms 110 are located outside in X direction relative to the antennas 30 when viewed from the second direction. Specifically, the first hinge mechanism 110A is located on the −X side relative to the first antenna 30A in X direction. The second hinge mechanism 110B is located on the +X side relative to the second antenna 30B in X direction.

As illustrated in FIG. 4, the cooling mechanism 40 is mounted in the second chassis 102. The cooling mechanism 40 includes a heat diffusion member 41 and two fans 42. The heat diffusion member 41 includes a metal plate 43 and a heat pipe 44. The metal plate 43 overlaps with a part of the motherboard 51 (second component) in plan view. A CPU (not illustrated) on the motherboard 51 is located so as to overlap the metal plate 43 in plan view. The heat pipe 44 is located on the lower face of the metal plate 43. The metal plate 43 is capable of exchanging heat with the CPU and other components.

The two fans 42 are placed apart in the X direction. The fans 42 are located outside in X direction relative to the heat diffusion member 41 in plan view. Each fan 42 has a release port 42a that releases air toward the inside of the X direction. The air released from the outlet 42a of each fan 42 passes over the surface of the heat diffusion member 41, thereby cooling the heat diffusion member 41. The air whose temperature has increased due to the heat exchange with the heat diffusion member 41 is discharged to the outside of the second chassis 102 through the exhaust ports 116 formed in the rear plate 115.

The antennas 30 are mounted in the second chassis 102. The antennas 30 are located in the vicinity of the second base end 102b of the second chassis 102.

The two antennas 30 are placed apart in X direction. The two antennas 30 are a first antenna 30A and a second antenna 30B. The first antenna 30A is, for example, a main antenna. The second 30B is, for example, an aux antenna. In one example, the antennas 30 are each a slot antenna. The direction in which the two antennas 30 are away from each other is outward in X direction. The direction in which the two antennas 30 are closer to each other is inward in X direction.

For instance, the two antennas 30 are located inside in X direction relative to the hinge mechanisms 110 (e.g., brackets). That is, the two antennas 30 are located inside in X direction relative to the hinge mechanisms 110 when viewed from the second direction. Specifically, the first antenna 30A is located on the +X side relative to the first hinge mechanism 110A in X direction. The second antenna 30B is located on the −X side relative to the second hinge mechanism 110B in X direction.

The two antennas 30 are located outside in X direction (the other side in the first direction) relative to the flexible boards 20 in X direction. That is, the two antennas 30 are located outside in X direction relative to the flexible boards 20 when viewed from the second direction. Specifically, the first antenna 30A is located on the −X side relative to the first flexible board 20A in X direction. The second antenna 30B is located on the +X side relative to the second flexible board 20B in X direction.

The two antennas 30 are each located between their corresponding hinge mechanism 110 (e.g., bracket) and flexible board 20 in X direction, for example. That is, the two antennas 30 are each located between the hinge mechanism 110 and the flexible board 20 when viewed from the second direction. Specifically, the first antenna 30A is located between the first hinge mechanism 110A and the first flexible board 20A in X direction. The second antenna 30B is located between the second hinge mechanism 110B and the second flexible board 20B in X direction.

The two flexible boards 20 are placed apart in X direction. The two flexible boards 20 are the first flexible board 20A and the second flexible board 20B. The direction in which the two flexible boards 20 are away from each other is outward in X direction. The direction in which the two flexible boards 20 are closer to each other is inward in X direction.

For instance, the two flexible boards 20 are located inside (one side in the first direction) in X direction relative to the hinge mechanisms 110 in the X direction. That is, the two flexible boards 20 are located inside in X direction relative to the hinge mechanisms 110 when viewed from the second direction. Specifically, the first flexible board 20A is located on the +X side relative to the first hinge mechanism 110A in X direction. The second flexible board 20B is located on the −X side relative to the second hinge mechanism 110B in X direction.

The two flexible boards 20 are located outside in X direction relative to the exhaust ports 116 in X direction. In other words, the exhaust ports 116 are located between the two flexible boards 20 in X direction.

As described above, the two antennas 30 are located outside of the flexible boards 20 in X direction. The two hinge mechanisms 110 are located outside of the antennas 30 in X direction. This means that the first flexible board 20A, the first antenna 30A, and the first hinge mechanism 110A are arranged side by side in this order in X direction. The second flexible board 20B, the second antenna 30B, and the second hinge mechanism 110B are arranged side by side in this order in X direction.

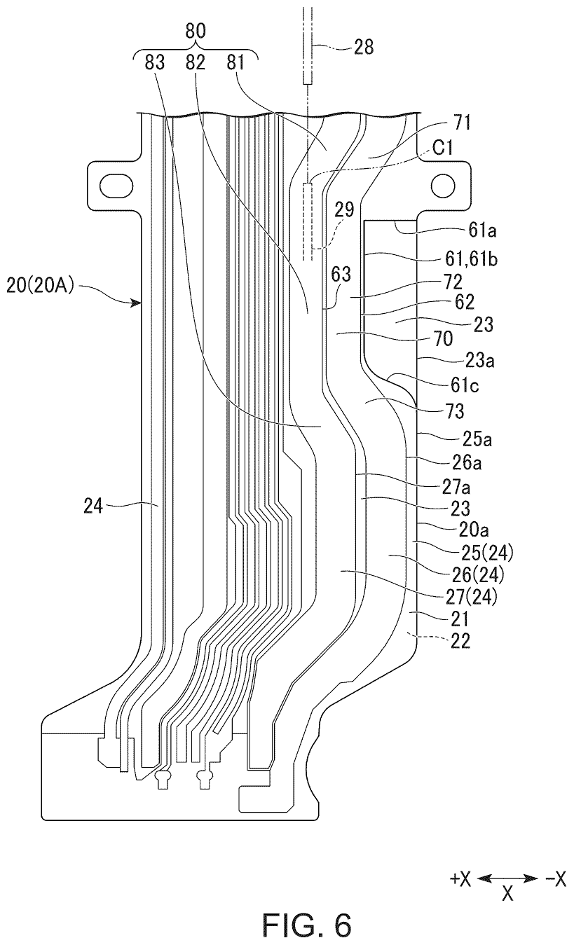

FIG. 6 is a partial plan view of the first flexible board 20A.

As illustrated in FIG. 6, the first flexible board 20A extends over the first chassis 101 and the second chassis 102 (see FIG. 1). The first flexible board 20A has one end that is electrically connected to a first component (e.g., display 103 (see FIG. 1)) mounted on the first chassis 101. The first flexible board 20A has the other end that is electrically connected to a second component (e.g., motherboard 51 (see FIG. 4)) mounted on the second chassis 102. In this embodiment, the upper end of the first flexible board 20A in FIG. 6 is connected to the first component. The lower end of the first flexible board 20A in FIG. 6 is connected to the second component.

For instance, the first flexible board 20A is a multilayer board having a first layer 21 and a second layer 22.

The first layer 21 includes a first substrate 23 (substrate) and a plurality of conductive layers 24. The first substrate 23 is flexible. The first substrate 23 is formed as a film or sheet. The first substrate 23 is made of, for example, polyimide or liquid crystal polymer.

The plurality of conductive layers 24 electrically connect the first component (e.g., display 103) to the second component (e.g., motherboard 51). The conductive layers 24 have one end that is directly or indirectly electrically connected to the first component. The conductive layers 24 have the other end that is directly or indirectly electrically connected to the second component. The conductive layers 24 extend linearly from the first component to the second component. These conductive layers 24 are aligned in the width direction (X direction) of the first flexible board 20A. The conductive layers 24 are made of metal such as copper.

The plurality of conductive layers 24 includes a first conductive layer 25, a second conductive layer 26, a third conductive layer 27, and a logic ground layer 28. The first conductive layer 25 is one of the conductive layers 24 that is on the most −X side. Of the conductive layers 24, the first conductive layer 25 is closest to the side edge 20a facing the first antenna 30a (see FIG. 4). The first conductive layer 25 is, for example, a ground layer.

The first conductive layer 25 has a recess 61 in the side edge 25a on the −X side (the side edge facing the first antenna 30A (see FIG. 4)). Preferably, the recess 61 is located at a position facing the first antenna 30A (see FIG. 4) in the longitudinal direction of the first flexible board 20A.

The recess 61 has a first edge 61a, a side edge 61b, and a second edge 61c. The side edge 61b is parallel to the longitudinal direction of the first flexible board 20A. The first edge 61a extends from one end of the side edge 61b toward the −X side. The second edge 61c starts from the other end of the side edge 61b and is inclined to be gradually away from the first edge 61a toward the −X side. The recess 61 is a trapezoidal cutout having the side edge 61b as the upper base and the edges 61a and 61c as legs. The first edge 61a is, for example, perpendicular to the side edge 61b. The second edge 61c is inclined at an angle greater than 90° relative to the side edge 61 b. The recess 61 is recessed toward the +X side (the direction away from the first antenna 30A (see FIG. 4)).

In other words, the first conductive layer 25 is narrowed to have the recess 61. The narrowing refers to the portion having a narrow width. In other words, the first conductive layer 25 is bent to be recessed toward the +X side to have the recess 61.

The second conductive layer 26 is a ground layer connected to the display 103 (see FIG. 1). The second conductive layer 26 is adjacent to the first conductive layer 25 on the +X side of the first conductive layer 25.

The second conductive layer 26 has a recess 62 in the side edge 26a on the −X side (the side edge facing the first antenna 30A (see FIG. 4)). Preferably, the recess 62 is located at a position facing the first antenna 30A (see FIG. 4) in the longitudinal direction of the first flexible board 20A.

The second conductive layer 26 has a bend 70. The bend 70 has an intermediate section 72 along the side edge 61b of the recess 61, and inclined sections 71 and 73 extending from both ends of the intermediate section 72 and away from each other toward the −X side. The bend 70 is bent to be recessed toward the +X side (the direction away from the first antenna 30A (see FIG. 4)). The recess 62 is on the inner edge of the bend 70. In other words, the second conductive layer 26 is bent to be recessed toward the +X side (the direction away from the first antenna 30A (see FIG. 4)), thereby defining the recess 62 in the side edge 26a.

The intermediate section 72 is narrower than the other portion of the second conductive layer 26 without the recess 62. In other words, the second conductive layer 26 has a narrow bend recessed toward the +X side to define the recess 62. The width of the inclined sections 71 and 73 decreases as they approach the intermediate section 72.

The third conductive layer 27 is a power layer connected to the display 103. The third conductive layer 27 is adjacent to the second conductive layer 26 on the +X side of the second conductive layer 26.

The third conductive layer 27 has a recess 63 in the side edge 27a on the −X side (the side edge facing the first antenna 30A (see FIG. 4)). Preferably, the recess 63 is located at a position facing the first antenna 30A (see FIG. 4) in the longitudinal direction of the first flexible board 20A.

The third conductive layer 27 has a bend 80. The bend 80 has an intermediate section 82 along the intermediate section 72 of the second conductive layer 26, and inclined sections 81 and 83 extending from both ends of the intermediate section 82 and away from each other toward the −X side. The bend 80 is bent to be recessed toward the +X side (the direction away from the first antenna 30A (see FIG. 4)). The recess 63 is on the inner edge of the bend 80. In other words, the third conductive layer 27 is bent to be recessed toward the +X side (the direction away from the first antenna 30A (see FIG. 4)), thereby defining the recess 63 in the side edge 27a.

The intermediate section 82 is narrower than the other portion of the third conductive layer 27 without the recess 63. In other words, the third conductive layer 27 has a narrow bend recessed toward the +X side to define the recess 63. The width of the inclined sections 81 and 83 decreases as they approach the intermediate section 82.

The logic ground layer 28 is to suppress a voltage drop in the display 103. The logic ground layer 28 has one end that is electrically connected to the display 103 (see FIG. 1). The logic ground layer 28 has the other end that is connected to a signal ground layer 29, as a conductive layer of the second layer 22. Thus, the logic ground layer 28 is electrically connected to the second component (e.g., motherboard 51) via the signal ground layer 29.

A connection point C1 between the logic ground layer 28 and the signal ground layer 29 is located at a position toward the display 103 from the recess 61 (C1 is at a position closer to the display 103 than the recess 61 is) in the longitudinal direction of first flexible board 20A. Therefore, in the position corresponding to the recess 61, the logic ground layer 28 is not formed on the first layer 21.

The first substrate 23 does not have a recess in the side edge 23a on the −X side (the side edge facing the first antenna 30A (see FIG. 4)). That is, the first flexible board 20A has the recess at the side edge on the −X side only in the conductive layer of the substrate and the conductive layer. This suppresses the degradation of the bending characteristics of the first flexible board 20A at the portion where the recess 61 is formed. Thus, the first flexible board 20A is less likely to be locally bent.

The second layer 22 includes a second substrate (not illustrated) and a plurality of conductive layers (not illustrated). The second substrate is flexible. The second substrate is formed as a film or sheet. The conductive layers are made of metal such as copper.

The plurality of conductive layers electrically connect the first component (e.g., display 103) to the second component (e.g., motherboard 51). The conductive layers have one end that is directly or indirectly electrically connected to the first component. The conductive layers have the other end that is directly or indirectly electrically connected to the second component. The conductive layers extend linearly from the first component to the second component. The plurality of conductive layers includes the signal ground layer 29.

Although the recesses 61 to 63 illustrated in FIG. 6 can be formed by both narrowing and bending the conductive layers 24, the recesses may be formed by either narrowing or bending the conductive layers 24. That is, the recesses may be formed by at least one of narrowing and bending the conductive layers.

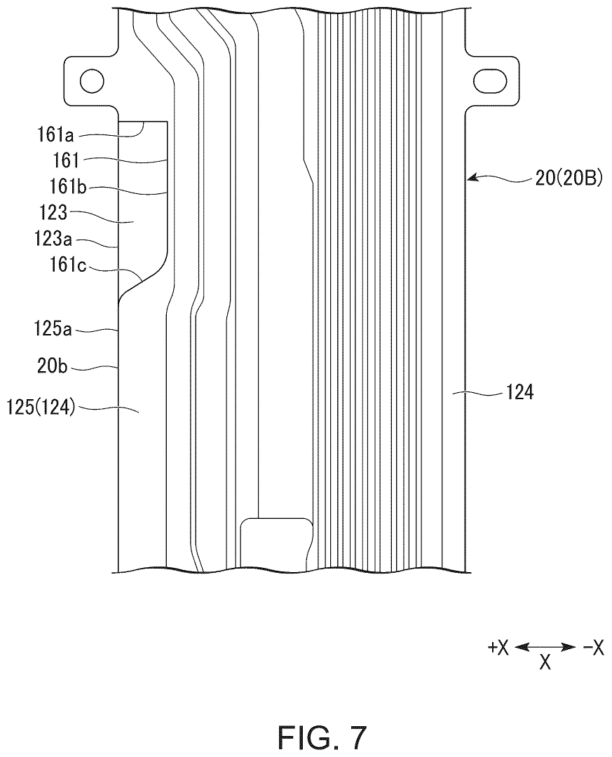

FIG. 7 is a partial plan view of the second flexible board 20B.

As illustrated in FIG. 7, the second flexible board 20B extends across the first chassis 101 and the second chassis 102 (see FIG. 1). The second flexible board 20B has one end that is electrically connected to a first component (e.g., camera 104 (see FIG. 1)) mounted on the first chassis 101. The one end of the second flexible board 20B may be electrically connected to various sensors mounted on the first chassis 101. The second flexible board 20B has the other end that is electrically connected to the second component (e.g., motherboard 51 (see FIG. 4)) mounted on the second chassis 102. In this embodiment, the upper end of the second flexible board 20B in FIG. 7 is connected to the first component. The lower end of the second flexible board 20B in FIG. 7 is connected to the second component.

The second flexible board 20B includes a substrate 123 and a plurality of conductive layers 124. The substrate 123 is flexible.

The plurality of conductive layers 124 electrically connect the first component (e.g., camera 104) to the second component (e.g., motherboard 51). The conductive layers 124 have one end that is directly or indirectly electrically connected to the first component. The conductive layers 124 have the other end that is directly or indirectly electrically connected to the second component. The conductive layers 124 extend linearly from the first component to the second component.

The plurality of conductive layers 124 includes a first conductive layer 125. The first conductive layer 125 is one of the conductive layers 124 that is on the most +X side. Of the conductive layers 124, the first conductive layer 125 is closest to the side edge 20b facing the second antenna 30B (see FIG. 4). The first conductive layer 125 is, for example, a signal ground layer.

The first conductive layer 125 has a recess 161 in the side edge 125a on the +X side (the side edge facing the second antenna 30B (see FIG. 4)). Preferably, the recess 161 is located at a position facing the second antenna 30B (see FIG. 4) in the longitudinal direction of the second flexible board 20B.

The recess 161 has a first edge 161a, a side edge 161b, and a second edge 161c. The side edge 161b is parallel to the longitudinal direction of the second flexible board 20B. The first edge 161a extends from one end of the side edge 161b toward the +X side. The second edge 161c starts from the other end of the side edge 161b and is inclined to be gradually away from the first edge 161a toward the +X side. The recess 161 is a trapezoidal cutout having the side edge 161b as the upper base and the edges 161a and 161c as legs. The first edge 161a is, for example, perpendicular to the side edge 161b. The second edge 161c is inclined at an angle greater than 90° relative to the side edge 161b. The recess 161 is recessed toward the −X side (the direction away from the second antenna 30B (see FIG. 4)).

In other words, the first conductive layer 125 is narrowed to have the recess 161. In other words, the first conductive layer 125 is bent to be recessed toward the −X side to have the recess 161.

Note that the recess may be formed by at least one of narrowing and bending the conductive layers. That is, the recess may be formed by at least one of narrowing and bending the conductive layers.

The first substrate 123 does not have a recess in the side edge 123a on the +X side (the side edge facing the second antenna 30B (see FIG. 4)). Thus, the second flexible board 20B has the recess at the side edge on the +X side only in the conductive layer of the substrate and the conductive layer. This suppresses the degradation of the bending characteristics of the second flexible board 20B at the portion where the recess 161 is formed. Thus, the second flexible board 20B is less likely to be locally bent.

### Advantageous Effects of Electronic Apparatus According to Embodiment

In the electronic apparatus 100 according to the embodiment, the conductive layers 24 (25, 26, 27) of the first flexible board 20A have the recesses 61 to 63 in the side edge on the −X side, which are formed by at least one of the narrowing and bending of the conductive layers 24. This configuration suppresses the electromagnetic influence of the conductive layers 24 on the first antenna 30A, and thus enhances the communication characteristics of the first antenna 30A. The conductive layers 124 of the second flexible board 20B have the recess 161 in the side edge on the +X side, which is formed by at least one of the narrowing and bending of the conductive layers 124. This configuration suppresses the electromagnetic influence of the conductive layers 124 on the second antenna 30B, and thus enhances the communication characteristics of the second antenna 30B. This allows the distance between the two flexible boards 20 to be large. This allows the exhaust ports 116 to be larger, and enhances the heat dissipation performance. In this way, the electronic apparatus 100 has communication characteristics of the antennas 30 enhanced without degrading the heat dissipation performance of the cooling mechanism 40.

In the electronic apparatus 100, the logic ground layer 28 is connected to the signal ground layer 29. This facilitates adjustment of the position of the logic ground layer 28.

In the electronic apparatus 100, the connection point C1 between the logic ground layer 28 and the signal ground layer 29 is located at a position toward the display 103 from the recess 61. This allows the depth dimension of the recesses 61 to be larger. This therefore improves the communication characteristics of the antenna 30.

The conductive layers 24 (25 to 27) are bent to be recessed on the +X side (the direction away from the first antenna 30A), allowing the depth dimensions of the recesses 61 to 63 to be larger. This therefore improves the communication characteristics of the antenna 30.

The Electronic Apparatus 100 Includes the Two Flexible boards 20 and the two antennas 30. This enhances the functionality of the electronic apparatus 100.

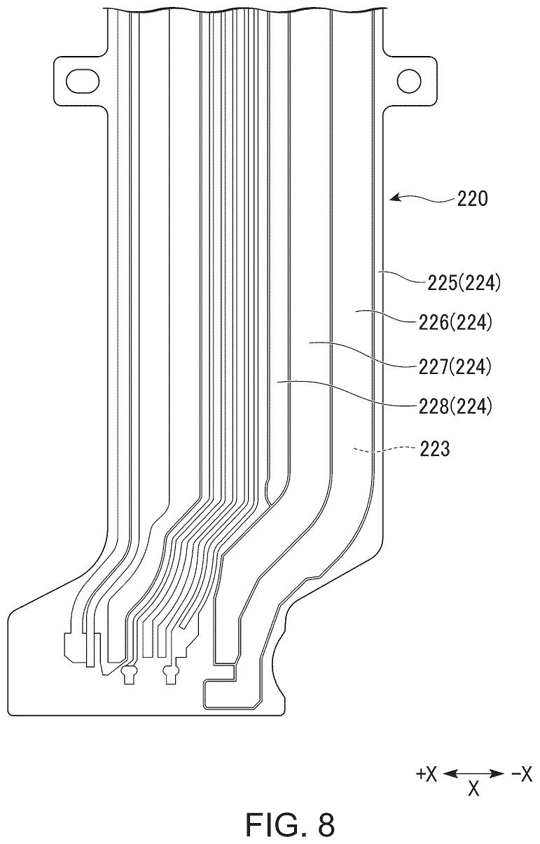

FIG. 8 is a partial plan view of a flexible board 220 according to a comparative example.

As illustrated in FIG. 8, the flexible board 220 includes a substrate 223 and a plurality of conductive layers 224. The conductive layers 224 include a first conductive layer 225, a second conductive layer 226, a third conductive layer 227, and a logic ground layer 228. The conductive layers 225 to 227 do not have recesses.

The second conductive layer 226 is adjacent to the first conductive layer 225 on the +X side of the first conductive layer 225. The third conductive layer 227 is adjacent to the second conductive layer 226 on the +X side of the second conductive layer 226. The logic ground layer 228 is adjacent to the third conductive layer 227 on the +X side of the third conductive layer 227. The logic ground layer 228 has one end that is electrically connected to the display 103 (see FIG. 1). The logic ground layer 228 has the other end that is electrically connected to the second component (e.g., motherboard 51). Thus, the logic ground layer 228 extends over the entire length of the flexible board 220.

In this flexible board 220 according to the comparative example, the logic ground layer 228 is located next to the conductive layers 225 to 227, so there is little space, and it is not easy to narrow and bend the conductive layers 225 to 227.

### Example

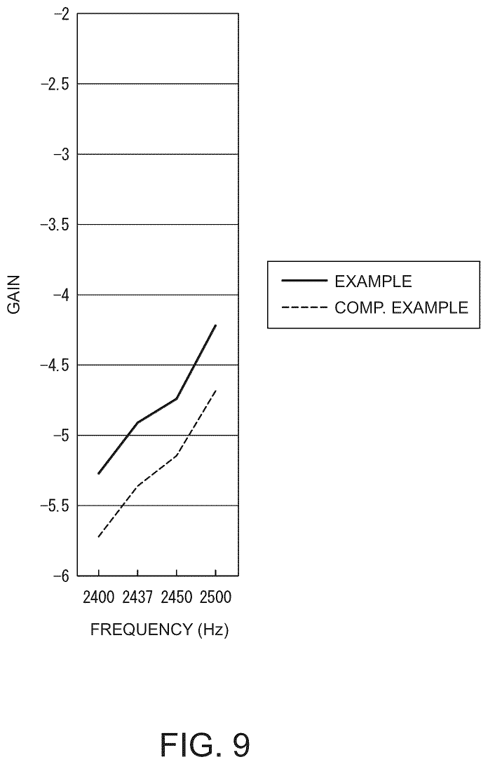

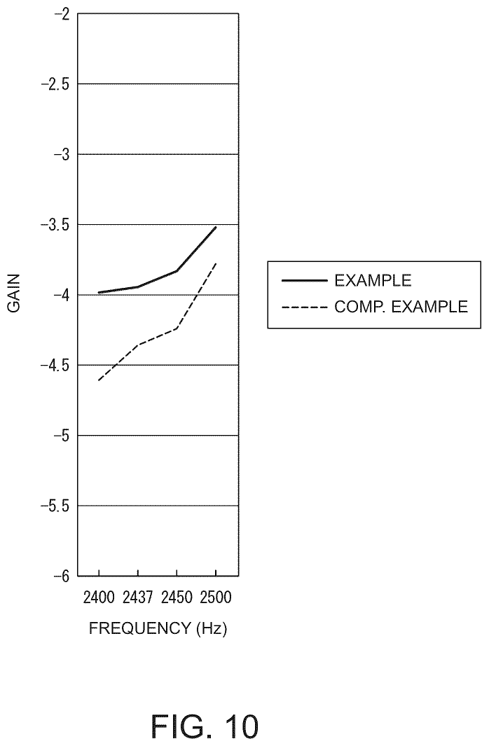

As illustrated in FIG. 6 and FIG. 7, an electronic apparatus was manufactured, including a flexible board 20 having recesses in the conductive layers 24. The gains of the first antenna 30A (MAIN) and the second antenna 30B (AUX) of this electronic apparatus were examined. FIG. 9 shows the results for the first antenna 30A (MAIN). FIG. 10 shows the results for the second antenna 30B (AUX).

### Comparative Example

As illustrated in FIG. 8, an electronic apparatus was manufactured similar to the above example except that no recess was formed in the conductive layers 224. The gains of the first antenna 30A (MAIN) and the second antenna 30B (AUX) of this electronic apparatus were examined. FIG. 9 shows the results for the first antenna 30A (MAIN). FIG. 10 shows the results for the second antenna 30B (AUX).

As shown in FIG. 9 and FIG. 10, it was confirmed that the example showed excellent antenna characteristics.

The specific configuration of the present invention is not limited to the above-described embodiments, and also includes designs or the like within the scope of the present invention. The configurations described in the above embodiments can be combined freely.

The electronic apparatus 100 illustrated in FIG. 1 includes the two hinge mechanisms 110. The number of hinge mechanisms 110 may be one or more (any number equal to or greater than two). The electronic apparatus 100 illustrated in FIG. 1 includes the two antennas 30. The number of antennas 30 may be one or more (any number equal to or greater than two).

The first flexible board 20A illustrated in FIG. 6 has the plurality of conductive layers 24. The number of conductive layers may be one or more (any number equal to or greater than two). The first flexible board 20A illustrated in FIG. 6 is a multilayer board having the first layer 21 and the second layer 22. The flexible board may be a single-layer board. For the multilayer flexible board, the number of layers may be two or more (any number equal to or greater than two).

1. An electronic apparatus comprising:
a first chassis having a first base end and a first open end, with a first component being mountable on the first chassis;
a second chassis having a second base end with an exhaust port and a second open end, with a second component being mountable on the second chassis;
at least one hinge mechanism rotatably connecting the first base end and the second base end;
at least one flexible board extending across the first chassis and the second chassis;
a cooling mechanism in the second chassis, the cooling mechanism configured to release air in the second chassis through an exhaust port; and
at least one antenna adjacent to the second base end of the second chassis,
the at least one flexible board, the at least one antenna, a the at least one hinge mechanism being disposed side by side in such foregoing order in a first direction that is an axial direction of the at least one hinge mechanism,
the at least one flexible board including:
a substrate that is flexible; and
at least one conductive layer on the substrate, the at least one conductive layer being configured to electrically connect the first component and the second component,
the at least one conductive layer having a recess in a side edge facing the at least one antenna, the recess including at least one of a narrow portion and a bend of the conductive layer.

2. The electronic apparatus according to claim 1, wherein
the first component is a display,
the at least one flexible board is a multilayer board having a first layer and a second layer,
the first layer includes the at least one conductive layer having a logic ground layer that is connectable to the display, the second layer includes the at least one conductive layer having a signal ground layer that is connectable to the display, and
the logic ground layer has one end that is electrically connectable to the display and another end that is electrically connected to the signal ground layer.

3. The electronic apparatus according to claim 2, wherein a connection point between the logic ground layer and the signal ground layer is located at adjacent to the display.

4. The electronic apparatus according to claim 1, wherein the at least one conductive layer with the recess has a bend recessed in a direction away from the at least one antenna.

5. The electronic apparatus according to claim 1, wherein
the at least one flexible board includes two flexible boards that are spaced apart in the first direction, the at least one antenna includes two antennas that are spaced apart in the first direction, and the at least one hinge mechanism includes two hinge mechanisms that are spaced apart in the first direction,
the exhaust port is between the two flexible boards in the first direction,
the two antennas are outside of the two flexible boards in t first direction, and
the two hinge mechanisms are outside of the two antennas in the first direction.
